(19) United States
(12) Patent Application Publication
(10) Pub. No.: US 2023/0238192 A1
(43) Pub. Date: Jul. 27, 2023

(54) Compact electromagnetic push switch assembly

(71) Applicant: Avan Tech Innovations Private Limited, Visakhapatnam (IN)

(72) Inventor: Pavan Kumar Gupta Boyina, Visakhapatnam (IN)

(73) Assignee: Avan Tech Innovations Private Limited, Visakhapatnam (IN)

(21) Appl. No.: 18/001,310

(22) PCT Filed: Jun. 7, 2021
(86) PCT No.: PCT/IN2021/050552

§ 371 Date: Dec. 9, 2022

(30) Foreign Application Priority Data
Jun. 10, 2020 (IN) 202041024260

(51) Int. Cl. H01H 1/54; H01H 3/50; H01H 13/62

(52) U.S. Cl. CPC H01H 1/54; H01H 3/503; H01H 13/62

(57) ABSTRACT

The present disclosure proposes acompact electromagnetic push switch assembly with integration of an electromagnetic coil to push switch that can be directly fixed to the panel without any extra items. The cost and space required in order to make electrical panels and starters are reduced and further provide automation in domestic and industrial automation areas. A compact electromagnetic push switch assembly 100 comprises of a switch section 101, an operating member 102, a primary rod structure 103, a secondary rod structure 104, a spring 105, an electromagnetic coil 106, and a control unit. The contactors and relays in pumps or motor controllers for tripping required items are also replaced with 1 Amp to 40 amp relays and the push switch is designed to operate with any required voltage and Amps with AC or DC supply. The electromagnetic push switch is used in domestic, industrial, agriculture, hospitals, etc.

The following specification particularly describes the invention and the manner in which it is to be performed:

### FIELD OF THE INVENTION

The present disclosure generally relates to push switch systems, and in specific relates to the integration of electromagnetic coil in push switch that can be directly fixed to the panel without any extra items.

### BACKGROUND OF THE INVENTION

Now-a-days, manually operated electromechanical device with a plurality of sets of electrical contacts is the most familiar form of switches. Each set of electrical contacts exists in any one of the two states, one is the electrical contacts are touching each other thereby electricity will flow between them in this state. In other state, the electrical contacts are separated and thereby the electricity will not flow between them and the switch is in nonconducting mode.

In general, electromagnetic switches are separately available in order to control motors and panels using relays, contactors, etc. However, they are not directly mounted to starter panel and electrical panels since it requires a relay base and channel.

In the current technology, an electromagnetic holding mechanism with push button actuating device and a switching device is used. By applying an actuating force, the push button assembly causes to depress the pushrod which engages to depress the plunger assembly. However, the cost and space required in order to make panel starters is high, and therefore, there exists a need to reduce the price and volume required to make the panel starters.

In the updated technology, an automatic power switching device is provided for household appliances such as heaters. It comprises of a push button, switch tongue, spring, bimetallic switch, and an electromagnetic coil. When the push button is pressed, the permanent magnet holds the switch tongue and supply power to the heater. The temperature rises at the heating element causing the bimetal switch tripped, then the electromagnetic coil is energized. However, the electromagnetic coil is not directly integrated thereby cannot hold the push button automatically.

Therefore, there exists a need to integrate an electromagnetic coil to push switch that can be directly fixed to the panel without any extra items. There exists a need to reduce the cost and space required in order to make electrical panels and starters and further provide automation in domestic and industrial automation areas. There exists a need to replace contactors and relays in pumps or motor controllers for tripping required items. There exists a need to replace 1 Amp to 40 Amprelays and provide a push switch that can be designed to operate with any required voltage and Amps with AC or DC supply.

### OBJECTIVES OF THE INVENTION

The primary objective of the invention is to integrate an electromagnetic coil to push switch that can be directly fixed to the panel without any extra items.

The other objective of the invention is to reduce the cost and space required in order to make electrical panels and starters and further provide automation in domestic and industrial automation areas.

Another objective of the invention is to replace contactors and relays in pumps or motor controllers for tripping required items.

Another objective of the invention is to replace relays with 1 Amp to 40 Amp and provide a push switch that can be designed to operate with any required voltage and Amps with AC or DC supply.

Yet another objective of the invention is to provide an electromagnetic push switch that can be used in domestic, industrial, agriculture, hospitals,home automation, inverters, electric control panels & startersetc.

Another objective of the invention is to provide an electromagnetic push switch which is durable, reliable, safe and maintenance-free.

Another objective of the invention is to provide an electromagnetic push switch which is easy to mount onto the panel without any additional mounting equipment.

### SUMMARY OF THE INVENTION

The present disclosure proposes acompact electromagnetic push switch assembly. The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

In order to overcome the above deficiencies of the prior art, the present disclosure is to solve the technicalproblem to provide integration of electromagnetic coil to the push switch that can be directly fixed to the panel without any extra items.

According to an aspect, a compact electromagnetic push switch assembly comprises of a switch section, an operating member, a primary rod structure, a secondary rod structure, a spring, an electromagnetic coil, and a control unit. The compact electromagnetic push switch assembly is directly fixed to the panel without using additional mounting elements. The compact electromagnetic push switch assembly is also utilized as auto control that includes Normally Closed (NC) whenever power is supplied and Normally Open (NO) whenever power supply is stopped.

The switch section includes an inner switch part and an outer switch part configured to initiate pressing operation. The operating member attached to the switch section is configured to project and retract with respect to the switch section and wherein the operating member further comprises of the primary rod structure, the secondary rod structure, and the spring that connects the primary rod structure and the secondary rod structure. In specific, the operating member is movable with respect to the switch section and aids in regaining its original position.

The electromagnetic coil is connected to the secondary rod structure and configured to attract and hold the primary rod structure with the secondary rod structure in same position when once the operating member gets depressed due to a pressing operation of the switch section until the power is cut. In specific, the electromagnetic coil is mounted at bottom part of the switch section and can be fixed at other part according to complications in manufacturing of the switch section. The electromagnetic coil is also used in normal domestic switches such as one-way electrical switch, two-way electrical switch or the like. The compact electromagnetic push switch assembly 100 has plurality of Terminals based upon its applications. The compact electromagnetic push switch assembly 100 has also been provided with the additional reset button in order to trip manually during worst case scenarios. The compact electromagnetic push switch assembly 100 has also been designed internally for electric protection by providing Fuse, Auto reset and other related circuit breakers.

Further, objects and advantages of the present invention will be apparent from a study of the following portion of the specification, the claims, and the attached drawings.

### DETAILED DESCRIPTION OF DRAWINGS

The accompanying drawings, which are incorporated in and constitute a part of the specification, illustrate an embodiment of the invention, and, together with the description, explain the principles of the invention.

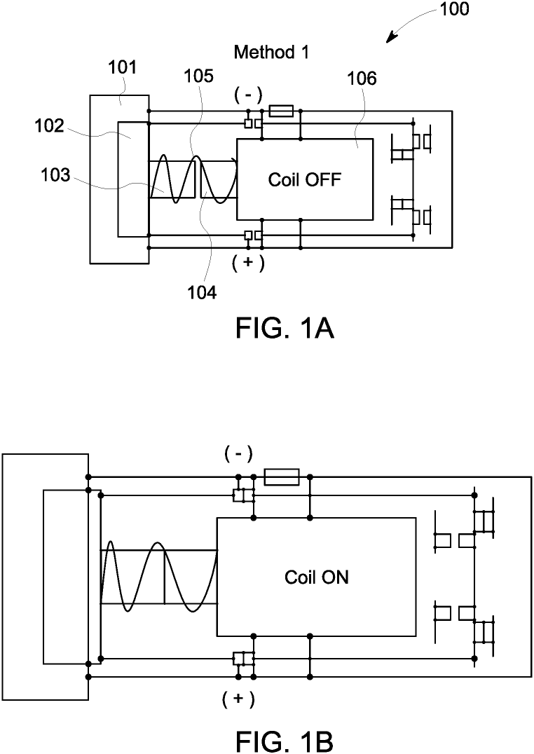

FIG. 1A illustrates a compact electromagnetic push switch assembly when operating member is not depressed in accordance to an embodiment of the invention.

FIG. 1B illustrates a compact electromagnetic push switch assembly when operating member is depressed in accordance to an embodiment of the invention.

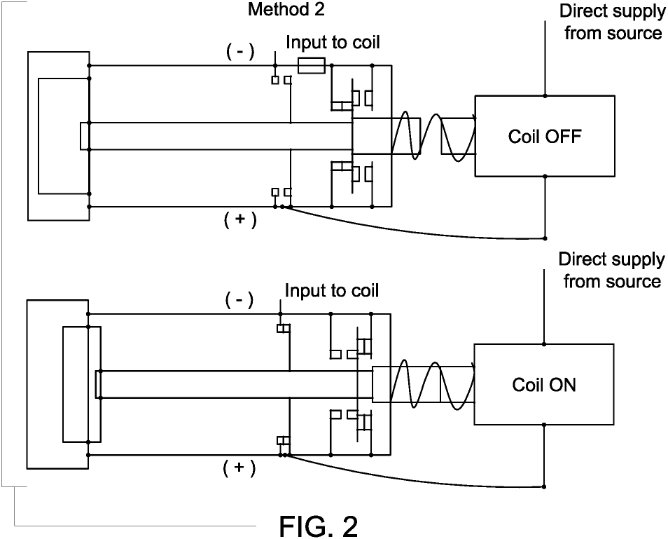

FIG. 2 illustrates a compact electromagnetic push switch assembly where electromagnetic coil is exterior in accordance to an embodiment of the invention.

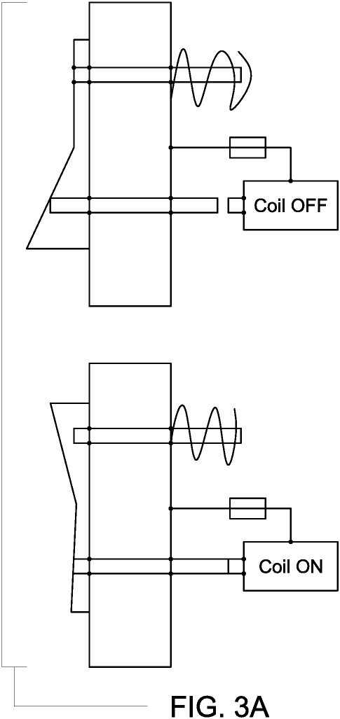

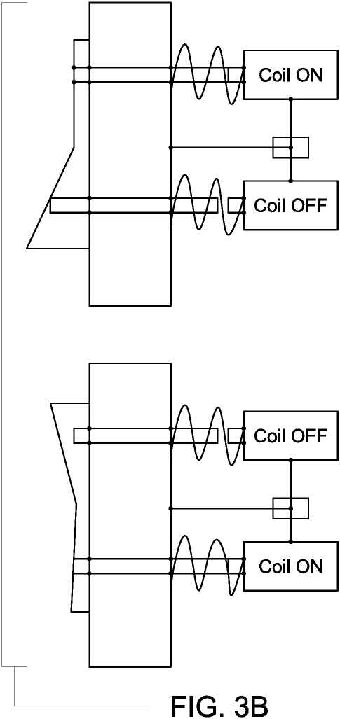

FIG. 3A illustrates an integration of a compact electromagnetic push switch assembly in normal domestic switch.

FIG. 3B illustrates an integration of a compact electromagnetic push switch assembly in normal domestic advanced switch.

### DETAILED INVENTION DISCLOSURE

Various embodiments of the present invention will be described in reference to the accompanying drawings. Wherever possible, same or similar reference numerals are used in the drawings and the description to refer to the same or like parts or steps.

The present disclosure has been made with a view towards solving the problem with the prior art described above, and it is an object of the present invention to provide integration of electromagnetic coil in push switch that can be directly fixed to the panel without any extra items.

According to an aspect, FIG. 1A illustrates a compact electromagnetic push switch assembly when operating member is not depressed. A compact electromagnetic push switch assembly 100 comprises of a switch section 101, an operating member 102, a primary rod structure 103, a secondary rod structure 104, a spring 105, an electromagnetic coil 106, and a control unit (not shown). The compact electromagnetic push switch assembly 100 is directly fixed to the panel without using additional mounting elements thereby it does not require much space and easier to mount. The compact electromagnetic push switch assembly 100 is also utilized as auto control that includes Normally Closed (NC) whenever power is supplied and Normally Open (NO) whenever power supply is stopped.

The switch section 101 includes an inner switch part and an outer switch part is configured to initiate pressing operation. The operating member 102 attached to the switch section is configured to project and retract with respect to the switch section 101 andwherein the operating member 102 further comprises of the primary rod structure 103, the secondary rod structure 104, and the spring 105 that connects the primary rod structure 103 and the secondary rod structure 104. In specific, the operating member 102 is movable with respect to the switch section 101 and aids in regaining its original position.

The electromagnetic coil 106 is connected to the secondary rod structure 104 and configured to attract and hold the primary rod structure 103 with the secondary rod structure 104 in same position when once the operating member 102 gets depressed due to a pressing operation of the switch section 101 until the power is cut. In specific, the electromagnetic coil 106 is mounted at bottom part of the switch section 101 and can be fixed at other part according to complications in manufacturing of the switch section 101. The position of the electromagnetic coil is replaced to middle or top of the push switch which depends upon complications in manufacturing of the push switch. The electromagnetic coil 106 is also used in normal domestic switches such as one-way electrical switch, two-way electrical switch or the like. The compact electromagnetic push switch assembly 100 has plurality of Terminals based upon its applications. In specific, the terminals included in contactors and relays are approximately six. The compact electromagnetic push switch assembly 100 has also been provided with the additional reset button in order to trip manually during worst case scenarios. The compact electromagnetic push switch assembly 100 has also been designed internally for electric protection by providing Fuse, Auto reset and other related circuit breakers.

FIG. 2 illustrates a compact electromagnetic push switch assembly where electromagnetic coil is exterior in accordance to an embodiment of the invention.

According to another aspect, FIGS. 3A and 3B illustrates an integration of a compact electromagnetic push switch assembly in normal domestic switch and normal domestic advanced switches. The electromagnetic coil is also arranged in normal domestic switches and normal domestic advanced switches. In normal domestic advanced switches, plurality of electromagnetic coils can be used based on the requirement. The push switch can also be operated manually by the user. When the user presses the push switch, the coil gets activated and holds the push switch in same switching position until or unless power is stopped.

The compact electromagnetic push switch assembly can also be utilized as auto controls in such a way that when power is supplied, the auto controls will Normally Closed (NC) and when power supply is stopped, the auto controls will Normally Open (NO) which is similar to relay and contactors.

Numerous advantages of the present disclosure may be apparent from the discussion above. In accordance with the present disclosure, a compact electromagnetic push switch assembly with integration of an electromagnetic coil to push switch is directly fixed to the panel without any extra items. The cost and space required in order to make electrical panels and starters are reduced and further provide automation in domestic and industrial automation areas. The contactors and relays in pumps or motor controllers for tripping required items are also replaced with 1 Amp to 40 Amp, ac or dc relays and the push switch is designed to operate with any required ac or dc voltage and Amps. The electromagnetic push switch is used in domestic, industrial, agriculture, hospitals, home automation, inverters, electric control panels & startersetc. The compact electromagnetic push switch assembly is durable, reliable, safe and maintenance-free.

The compact electromagnetic coil push switch assembly also works similar to the relay and contactor. The proposed compact electromagnetic push switch assembly can also be directly fixed to the panel using plurality of holes. The compact electromagnetic push switch assembly has also been designed with an inbuilt electric protection by providing fuse, auto reset and other related circuit breakers.

It will readily be apparent that numerous modifications and alterations can be made to the processes described in the foregoing examples without departing from the principles underlying the invention, and all such modifications and alterations are intended to be embraced by this application.

I / We claim:

1. A compact electromagnetic push switch assembly, comprising:
a switch section that includes an inner switch part and an outer switch part configured to initiate pressing operation;
an operating member attached to said switch section configured to project and retract with respect to the switch section,wherein said operating member further comprises:
a primary rod structure,
a secondary rod structure, and
a spring connecting the primary rod structure and the secondary rod structure;
an electromagnetic coil connected to the secondary rod structure and configured to attract and hold said primary rod structure with the secondary rod structure in same position when once the operating member gets depressed due to a pressing operation of the switch section until the power is cut; and
a control unit configured to enable power supply to the electromagnetic coil and energize the coil once the switching contacts get closed,
wherein said compact electromagnetic push switch assembly is directly fixed to the panel without using additional mounting elements.

2. The compact electromagnetic push switch assembly as recited in claim 1, wherein said switch section module regains its original position in case of power cut.

3. The compact electromagnetic push switch assembly as recited in claim 1, wherein said primary rod structure is attached to said switch section module at a predetermined length or less.

4. The compact electromagnetic push switch assembly as recited in claim 1, wherein said operating member is movable with respect to said switch section module and aids in regaining its original position.

5. The compact electromagnetic push switch assembly as recited in claim 1, wherein said electromagnetic coil is mounted at bottom part of said switch section module and changed according to complications in manufacturing of said switch section module.

6. The compact electromagnetic push switch assembly as recited in claim 1, wherein said compact electromagnetic push switch assembly is also utilized as auto controls that include Normally Closed (NC) whenever power is supplied and Normally Open (NO) whenever power supply is stopped.

7. The compact electromagnetic push switch assembly as recited in claim 1, wherein said electromagnetic coil is also used in normal domestic switches such as one-way electrical switch, two-way electrical switch or the like.

8. The compact electromagnetic push switch assembly as recited in claim 1, wherein said compact electromagnetic push switch has plurality of terminals based upon the applications.

9. The compact electromagnetic push switch assembly as recited in claim 1, wherein said compact electromagnetic push switch has also been provided additional reset button to trip manually it will reset in case any failure.

10. The compact electromagnetic push switch assembly as recited in claim 1, wherein said compact electromagnetic push switch assembly replaces relays with 1 Amp to 40 Amp and provide a push switch that can be designed to operate with any required voltage and Amps with AC or DC supply.
